(19) United States
(12) Patent Application Publication
(10) Pub. No.: US 2005/0222872 A1
(43) Pub. Date: Oct. 6, 2005

(54) Information processing system, medical system and information processing method

(75) Inventor: Sumiya Nagatsuka, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/091,615

(22) Filed: Mar. 29, 2005

(30) Foreign Application Priority Data
Apr. 1, 2004 (JP) 2004-109198

(51) Int. Cl. G06F 17/60; G01N 23/04

(52) U.S. Cl. 705/2

(57) ABSTRACT

An information processing system includes a plurality of information processing apparatuses for performing an information process according to a program, the plurality of information processing apparatuses being connected to each other through a network, wherein a plurality of types of application programs corresponding to a plurality of types of processing functions required in the information processing system are preliminarily stored in each of the plurality of information processing apparatuses, a designating section designates an application program among the plurality of types of application programs to each of the plurality of information processing apparatuses through the network, the application program corresponding to a processing function to be executed by the each of the plurality of information processing apparatuses, and the each of the plurality of information processing apparatuses executes the designated application program.

### BACKGROUND OF THE INVENTION

1. Field of the Invention

The present invention relates to an information processing system comprising a plurality of information processing apparatuses connected to each other through a network. In detail, the present invention relates to a medical system having a plurality of medical apparatuses connected to each other through a network, and an information processing method.

2. Description of Related Art

These days, in a hospital or among hospitals, a medical system comprising a plurality of medical apparatuses connected to each other through a network is built. For example, in a medical system using a CR (Computed Radiography) apparatus, a plurality of medical apparatuses are connected to each other through a network, the plurality of medical apparatuses comprising: a medical image reading apparatus for reading radiation image information of a subject, the radiation image information being accumulated in a photostimulable phosphor plate by a radiography, and for generating medical image data; a control apparatus for relating the read medical image data with image generation order information, for displaying a medical image, for applying an image processing on the medical image data, and the like; an image server for storing the medical image data; a printer for recording an image on a recording medium based on the medical image data to be outputted; and the like. Thereby, efficiency of operations in the hospital is improved.

In each medical apparatus structuring such a medical system, an application program corresponding to a processing function required to each medical apparatus is installed, and each medical apparatus performs an information processing required to each apparatus in the medical system according to the installed application program. For a network system comprising such large number of medical apparatuses, a technology for efficiently managing the latest version of software components such as an application program and the like (version up) has been proposed (for example, see JP-TokukaiHei-11-306000A).

By the way, conventionally, when a whole functional structure of a medical system is to be changed, the change is so performed that a hardware structure of the medical system is changed and an application program corresponding to a processing function required to each apparatus structuring the medical system is installed in each apparatus. Here, since the installation of the application program to each apparatus requires professional knowledge and technique, the installation is conventionally performed by a service person of the manufacturer. Thereby, it is necessary to take a large number of steps. Accordingly, it is not possible to flexibly change a functional structure of the medical system according to a situation.

### SUMMARY OF THE INVENTION

An object of the present invention is to be capable of easily changing a functional structure of an information processing system, the information processing system comprising a plurality of information processing apparatuses connected through a network. In more detail, an object of the present invention is to be capable of easily changing a functional structure of a medical system, the medical system comprising a plurality of medical apparatuses connected through a network.

In accordance with a first aspect of the present invention, an information processing system comprises a plurality of information processing apparatuses for performing an information process according to a program, the plurality of information processing apparatuses being connected to each other through a network, wherein a plurality of types of application programs corresponding to a plurality of types of processing functions required in the information processing system are preliminarily stored in each of the plurality of information processing apparatuses, a designating section designates an application program among the plurality of types of application programs to each of the plurality of information processing apparatuses through the network, the designated application program corresponding to a processing function to be executed by the each of the plurality of information processing apparatuses, and the each of the plurality of information processing apparatuses executes the designated application program.

In accordance with a second aspect of the present invention, a medical system comprises: an information management apparatus for generating and managing image generation order information; at least one image generating apparatus for generating medical image data from a subject; and at least one control apparatus for obtaining the image generation order information from the information management apparatus and the medical image data from one of the at least one image generating apparatus, and for relating the obtained image generating order information and the obtained medical image data; wherein the information management apparatus, the at least one image generating apparatus and the at least one control apparatus are connected to each other through a network, a plurality of types of application programs corresponding to a plurality of types of processing functions concerning a generation and a transmission of the medical image data, the plurality of types of processing functions being required in the medical system, are preliminarily stored in each of the at least one image generating apparatus, a plurality of types of application programs corresponding to a plurality of types of processing functions concerning an obtaining of the image generation order information from the information management apparatus, an obtaining of the medical image data from one of the at least one image generating apparatus and a relation between the obtained image generation order information and the obtained medical image data, the plurality of processing functions being required in the medical system, are preliminarily stored in each of the at least one of control apparatus, the medical system further comprises a system management apparatus connected to the at least one image generating apparatus and the at least one control apparatus through the network, the system management apparatus designates an application program among the plurality of types of application programs stored in each of the at least one image generating apparatus and/or the plurality of types of application programs stored in each of the at least one control apparatus to each of the at least one image generating apparatus and/or the at least one control apparatus, the application program corresponding to a processing function to be executed by the each of the at least one image generating apparatus and/or each of the at least one control apparatus, and the each of the at least one image generating apparatus and/or the at least one control apparatus executes the designated application program.

Preferably, in the system of the second aspect, at least one apparatus of the medical system is connected through the network to a data processing apparatus for applying a data processing to the medical image data, a plurality of types of application programs corresponding to a plurality of types of processing functions concerning a reception of the medical image data from the at least one control apparatus, a reception of the parameter from the at least one control apparatus and a data processing to the received medical image data based on the parameter received from the at least one control apparatus, the plurality of types of processing functions being required in the medical system, are preliminarily stored in the data processing apparatus, the system management apparatus informs the data processing apparatus through the network, of whether an application program corresponding to a processing function to be executed by the data processing apparatus is designated among the plurality of types of application programs stored in the data processing apparatus or there is no application program to be designated, and the data processing apparatus executes the designated application program when the system management apparatus designates the application program, or the data processing apparatus does not function when the system management apparatus informs the data processing apparatus that there is no application program to be designated.

Preferably, in the system of the second aspect, at least one apparatus of the medical system is connected through the network to a data processing apparatus for applying a data processing to the medical image data, a plurality of types of application programs corresponding to a plurality of types of processing functions concerning a reception of the medical image data from the at least one control apparatus, a reception of the parameter from the at least one control apparatus and a data processing to the received medical image data based on the parameter received from the at least one control apparatus, the plurality of types of processing functions being required in the medical system, are preliminarily stored in the data processing apparatus, each of the at least one control apparatus judges whether a function mode thereof is a mammo mode or not based on the type of the application program designated by the system management apparatus, and when the function mode is judged as the mammo mode, each of the at least one control apparatus gives an instruction to the data processing apparatus through the network to function, and the data processing apparatus performs the plurality of types of application programs stored therein when one of the at least one control apparatus gives the instruction to function.

Preferably, in the system of the second aspect, selected one of the at least one control apparatus works as the system management apparatus.

In accordance with a third aspect of the present invention, an information processing method in an information processing system comprising a plurality of information processing apparatuses for performing an information process according to a program, the plurality of information processing apparatuses being connected to each other through a network, comprises: preliminarily storing a plurality of types of application programs in each of the plurality of information processing apparatuses, the plurality of types of application programs corresponding to a plurality of types of processing functions required in the information processing system; designating an application program among the plurality of types of application programs to each of the plurality of information processing apparatuses, the application program corresponding to a processing function to be executed by the each of the plurality of information processing apparatuses, and making the each of the plurality of information processing apparatuses execute the designated application program.

In accordance with a fourth aspect of the present invention, an information processing method in a medical system comprising: an information management apparatus for generating and managing image generation order information; at least one image generating apparatus for generating medical image data from a subject; and at least one control apparatus for obtaining the image generation order information from the information management apparatus, for obtaining the medical image data from the image generating apparatus, and for relating the obtained image generation order information and the obtained medical image data; wherein the information management apparatus, the at least one image generating apparatus and the at least one control apparatus are connected to each other through a network, comprises: preliminarily storing a plurality of types of application programs corresponding to a plurality of types of processing functions concerning a generation and a transmission of the medical image data in each of the at least one image generating apparatus, the plurality of types of processing functions being required in the medical system, in each of the at least one image generating apparatus; preliminarily storing a plurality of types of application programs corresponding to a plurality of types of processing functions concerning an obtaining of the image generation order information from the information management apparatus, an obtaining of the medical image data from one of the at least one image generating apparatus and a relation between the obtained image generation order information and the obtained medical image data, the plurality of types of processing functions being required in the medical system, in each of the at least one control apparatus; making a system management apparatus connected to the at least one control apparatus through the network designate an application program among the plurality of types of application programs stored in each of the at least one image generating apparatus and/or the plurality of types of application programs stored in each of the at least one control apparatus through the network to each of the at least one image generating apparatus and/or each of the at least one control apparatus, the application program corresponding to a processing function to be executed by the each of the at least one image generating apparatus and/or the at least one control apparatus, and making the each of the at least one image generating apparatus and/or each of the at least one control apparatus execute the designated application program.

Preferably, in the method of the fourth aspect, at least one apparatus of the medical system is through the network connected to a data processing apparatus for applying a data processing to the medical image data, the method further comprises: preliminarily storing a plurality of types of application programs corresponding to a plurality of types of processing functions concerning a reception of the medical data from the at least one control apparatus, a reception of a parameter from the at least one control apparatus and the data processing to the received medical image data based on the parameter received from the at least one control apparatus, the plurality of types of processing functions being required in the medical system, in the data processing apparatus; making the system management apparatus inform the data processing apparatus through the network, of whether an application program corresponding to a processing function to be executed by the data processing apparatus is designated among the plurality of types of application programs stored in the data processing apparatus or there is no application program to be designated; and making the data processing apparatus execute the designated application program when the system management apparatus designates the application program, and making the data processing apparatus not function when the data processing apparatus is informed that there is no application program to be designated.

Preferably, in the method of the fourth aspect, at least one apparatus of the medical system is connected through the network to a data processing apparatus for applying a data processing to the medical image data, the method further comprises: preliminarily storing a plurality of types of application programs corresponding to a plurality of types of processing functions concerning a reception of the medical image data from the at least one control apparatus, a reception of a parameter from the at least one control apparatus and the data processing to the received medical image data based on the parameter received from the at least one control apparatus, the plurality of types of processing functions being required in the medical system, in the data processing apparatus; making the at least one control apparatus judge whether a function mode thereof is a mammo mode or not based on a type of the application program designated by the system management apparatus, and instruct the data processing apparatus through the network to function when the function mode is judged as the mammo mode; and making the data processing apparatus execute the plurality of types of application programs stored therein when the at least one control apparatus instructs the data processing apparatus to function.

Preferably, in the method of the fourth aspect, selected one of the at least one control apparatus works as the system management apparatus.

According to the first and third aspects of the present invention, in an information processing system comprising a plurality of information processing apparatuses connected through a network, each information processing apparatuses performing an information processing according to a program, a plurality of types of application programs corresponding to a plurality of types of processing functions required in the information processing system are preliminarily stored in each of the plurality of information processing apparatuses, an application program corresponding to a processing function to be executed by each of the plurality of information processing apparatuses is designated to each of the plurality of information processing apparatuses through the network, and each of the plurality of information processing apparatuses executes the designated application program.

Therefore, it is possible to easily change a functional structure of the information processing system by only designating the application program to be executed by each information processing apparatus among the application programs corresponding to the plurality of types of processing functions preliminarily stored in each information processing apparatus. Accordingly, although conventionally it was necessary to have a complicated operation that makes a staff of manufacturer individually install an application soft corresponding to a processing function to be executed by each apparatus at each time of changing a functional structure of the system, it is not necessary to do the same any more with the present invention.

According to the second and fourth aspects of the present invention, in a medical system comprising: an information management apparatus for generating and managing image generation order information; at least one image generating apparatus for generating medical image data from a subject; and at least one control apparatus for obtaining the image generation order information from the information management apparatus, for obtaining the medical image data from the at least one image generating apparatus and for relating the image generation order information and the medical image data, wherein the information management apparatus, the at least one image generating apparatus and the at least one control apparatus are connected to each other through a network, application programs corresponding to a plurality of types of processing functions concerning a generation and a transmission of the medical image data, the plurality of types of processing functions being required in the medical system, are preliminarily stored in each of the at least one image generating apparatus, application programs corresponding to a plurality of types of processing functions concerning an obtaining of the image generation order information from the information management apparatus, an obtaining of the medical image data from the at least one image generating apparatus and a relation between the obtained image generation order information and the obtained medical image data, the plurality of types of processing functions being required in the medical system, are preliminarily stored in each of the at least one control apparatus, a system management apparatus connected to the at least one image generating apparatus and the at least one control apparatus through the network is used to designate an application program to each of the at least one image generating apparatus and/or each of the at least one control apparatus, the application program corresponding to a processing function to be executed by each apparatus, and each of the at least one image generating apparatus and/or the at least one control apparatus executes the designated application program.

Therefore, by only designating the application program corresponding to a processing function to be executed by each apparatus among application programs corresponding to a plurality of types of processing functions, the application programs being preliminarily stored in each of at least one image generating apparatus and/or at least one control apparatus, it is possible to easily change a functional structure of the medical system. Accordingly, although conventionally it was necessary to have a complicated operation that makes a staff of manufacturer individually install an application soft corresponding to a processing function to be executed by each apparatus at each time of changing a functional structure of the system, it is not necessary to do the same any more with the present invention.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a view showing a whole structure of a medical system 100 relating to the present invention,

FIG. 2 is a view showing a program storing example of a storing unit of control apparatuses 1a to 1c,

FIG. 3 is a view showing a program storing example of a storing unit of image reading apparatuses 2a and 2b,

FIG. 4 is a view showing a program storing example of a storing unit of a mammo-use processor 3,

FIG. 5A is a view showing a data storing example of a system structure setting table 501 stored in a storing unit of a JOB manager 5, FIG. 5B is a view showing a data storing example of a system structure detail setting table 502 stored in the storing unit of the JOB manager 5, FIG. 5C is a view showing a data storing example of a selectable application soft list table 503 stored in the storing unit of the JOB manager 5,

FIG. 6 is a flowchart illustrating an application soft selecting process performed in the medical system 100,

FIG. 7 is a view showing a functional structure example of the medical system 100, and

FIG. 8 is a view showing a functional structure example of the medical system 100.

### PREFERRED EMBODIMENTS OF THE INVENTION

Hereinafter, an embodiment of the present invention will be described in detail. However, a scope of the invention is not limited to the illustrated examples.

First, a structure of the present embodiment will be described.

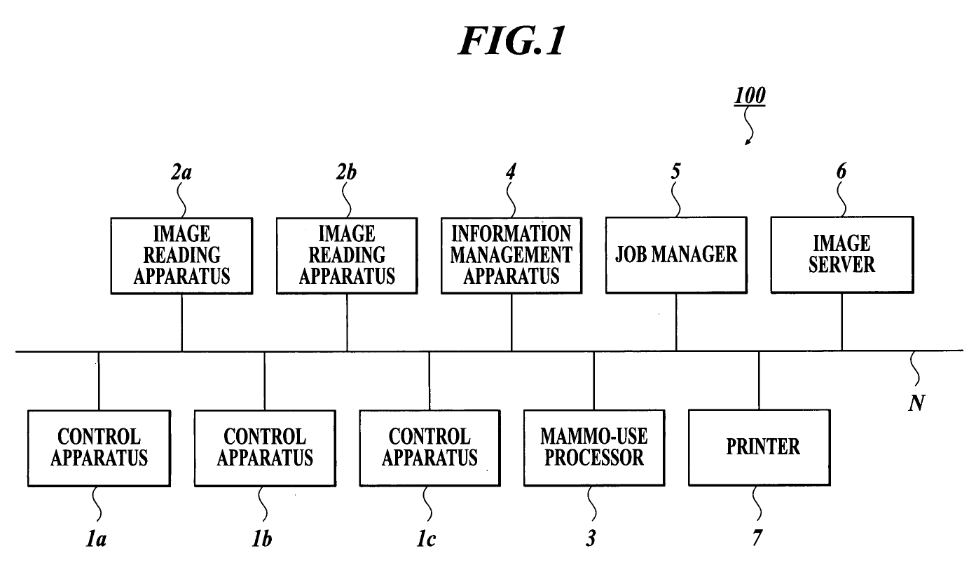

FIG. 1 is a schematic view showing a system structure of a medical system 100 in the present embodiment. As shown in FIG. 1, the medical system 100 comprises control apparatuses 1a to 1c, image reading apparatuses 2a and 2b, a mammo-use processor 3, an information management apparatus 4, a JOB manager 5, an image server 6, a printer 7 and the like, each of which is connected through a network N so as to make it possible to mutually transmit/receive data.

Each of the control apparatuses 1a to 1c, the image reading apparatuses 2a and 2b, and the mammo-use processor 3 corresponds to an information processing apparatus of the present invention for performing an information processing according to an application program, and the medical system 100 corresponds to an information processing system of the present invention to which apparatuses including the control apparatuses 1a to 1c, the image reading apparatuses 2a and 2b and the mammo-use processor 3 are connected through a network.

As the network N, various types of line forms such as a LAN (Local Area Network), a WAN (Wide Area Network), Internet or the like are applicable. Here, if permitted in a medical institution such as a hospital or the like, the network N may take a wireless communication or an infrared ray communication, where preferably information to be transmitted/received is encoded since the information includes important patient information. Further, as a communication system in the hospital, in general, DICOM (Digital Image and Communications in Medicine) standard is used. For communications among each apparatus on the network N as mentioned above, DICOM MWM (Modality Worklist Management) or DICOM MPPS (Modality Performed Procedure Step) is used.

The control apparatuses 1a to 1c are apparatuses for relating image generation order information obtained from the information management apparatus 4 with medical image data read by the image reading apparatuses 2a and 2b, for displaying a medical image to confirm its position, for performing an image processing on the medical image data, or the like. Each of the control apparatuses 1a to 1c comprises a CPU (Central Processing Unit); a RAM (Random Access Memory); a storing unit comprising one of a magnetic recording medium, an optical recording medium and a semiconductor memory; a monitor such as a CRT (Cathode Ray Tube), a liquid crystal display, a plasma display or the like; an operating section such as a mouse, a keyboard and the like; and a communication section for controlling communications to each apparatus on the network N.

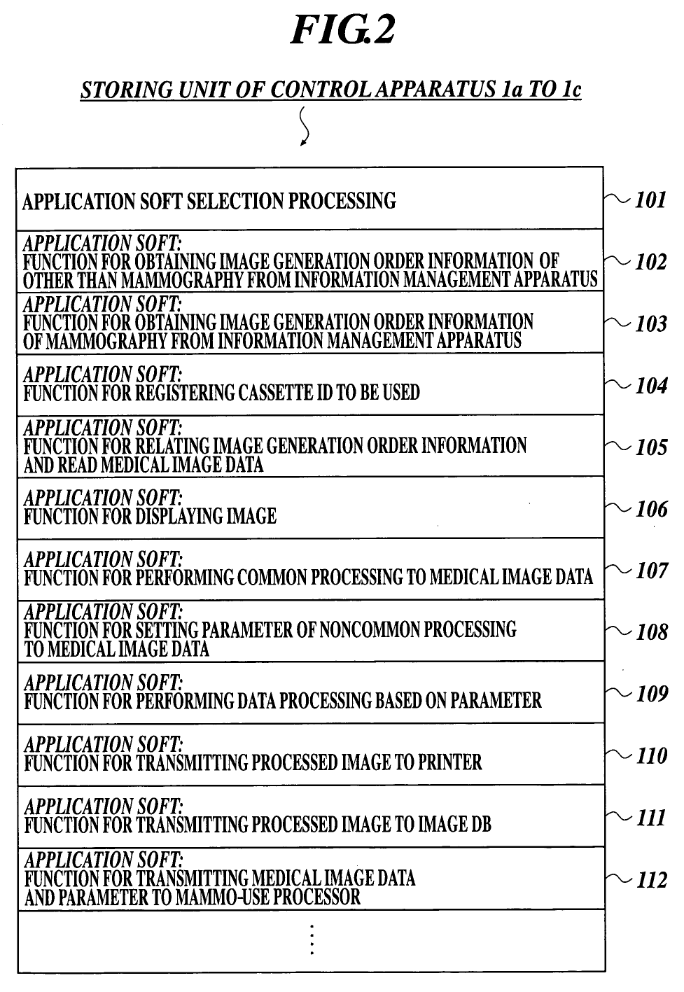

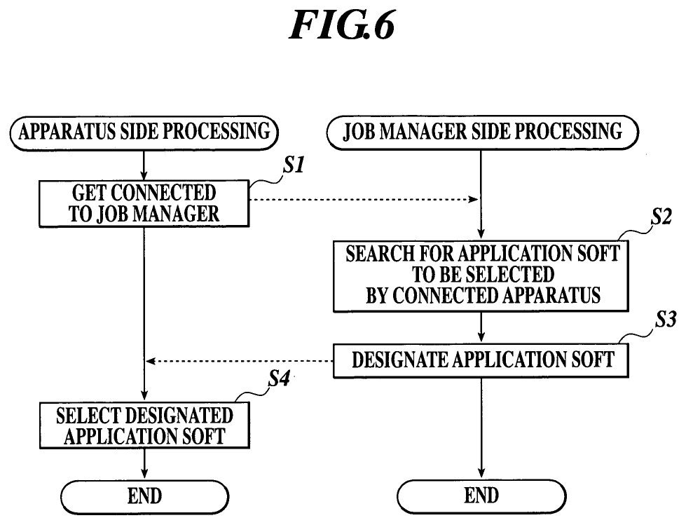

In the present embodiment, as shown in FIG. 2, the storing unit of each of the control apparatuses 1a to 1c stores an application soft selection processing program 101 and application softs 102 to 112. The application softs 102 to 112 are application programs in a form readable by a computer, for realizing each processing function shown in FIG. 2. The CPU of each of the control apparatuses 1a to 1c, by a software processing in conjunction with various programs stored in the above-mentioned storing unit, executes and realizes various processes such as an apparatus side processing of the application soft selection process (see FIG. 6), which will be described later, and the processing functions of the application softs 102 to 112.

The image reading apparatuses 2a and 2b are image generating apparatuses for reading radiation image information of a subject, the radiation image information being recorded in a loaded cassette, and for generating medical image data. Each of the image reading apparatuses 2a and 2b comprises: a CPU; a RAM; a storing unit comprising one of a magnetic recording medium, an optical recording medium and a semiconductor memory; an image reading section for generating medical image data by irradiating an excitation light to a photostimulable phosphor sheet of the loaded cassette, photoelectrically converting a fluorescent light emitted from the sheet, and analog-digital converting the obtained image signal; a cassette ID reading section for optically reading a cassette ID which is to uniquely distinguish the cassette; a communication section for controlling communications to each apparatus on the network N; and the like.

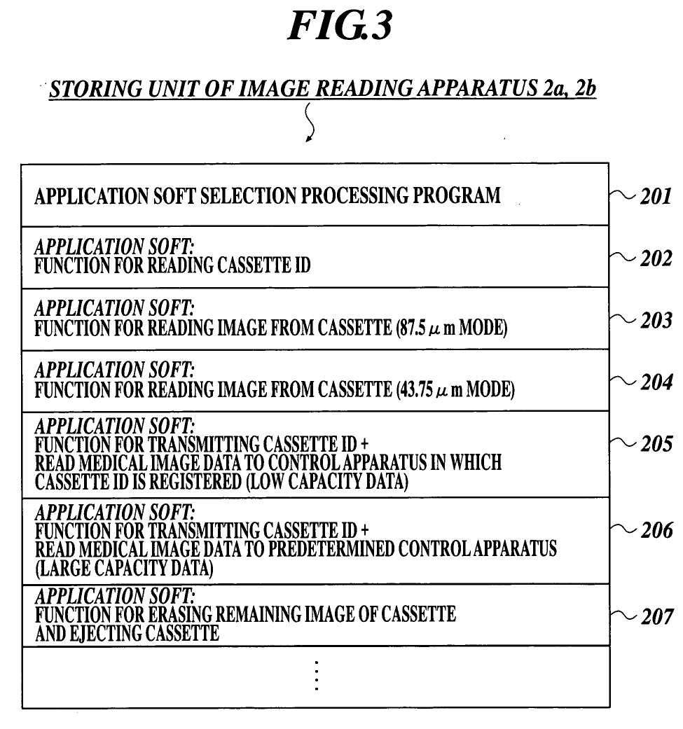

In the present embodiment, as shown in FIG. 3, the storing unit of each of the image reading apparatuses 2a and 2b stores an application soft selection processing program 201 and application softs 202 to 207. The application softs 202 to 207 are application programs in a form readable by a computer, for realizing each processing function shown in FIG. 3. The CPU of each of the image reading apparatuses 2a and 2b, by a software processing in conjunction with various programs stored in the above-mentioned storing unit, executes and realizes various processes such as an apparatus side processing of an application soft selection process (see FIG. 6), which will be described later, and the processing functions of the application softs 202 to 207.

The mammo-use processor 3 is an apparatus for applying an image process on mammography, which has larger data amount than an image of other parts for image generation. The mammo-use processor 3 comprises: a CPU; a RAM; a storing unit comprising one of a magnetic recording medium, an optical recording medium and a semiconductor memory; a monitor such as a CRT, a liquid crystal display, a plasma display or the like; an operating section such as a mouse, a keyboard and the like; a communication section for controlling communications to each apparatus on the network N; and the like.

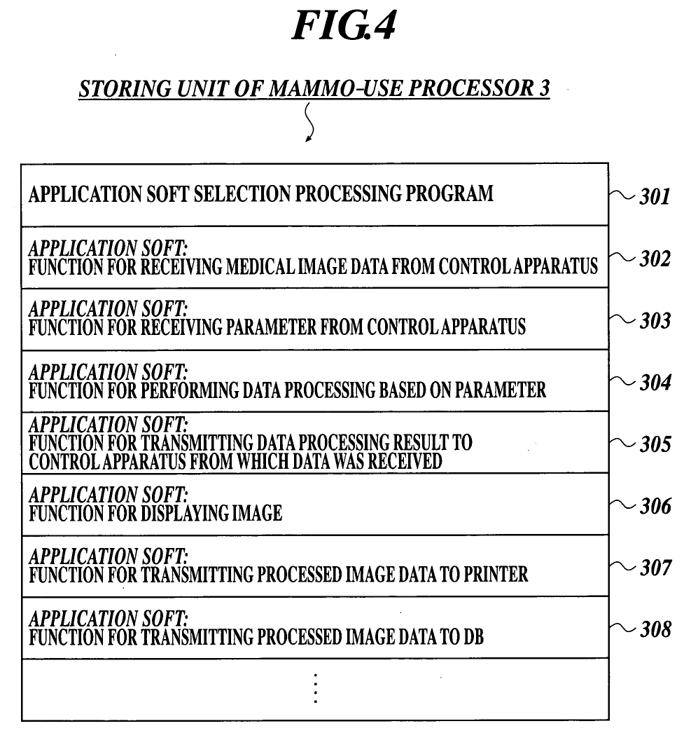

In the present embodiment, as shown in FIG. 4, the storing unit of the mammo-use processor 3 stores an application soft selection processing program 301 and application softs 302 to 308. The application softs 302 to 308 are application programs in a form readable by a computer, for realizing each processing function shown in FIG. 4. The CPU of each of the mammo-use processor 3, by a software processing in conjunction with various programs stored in the above-mentioned storing unit, executes and realizes various processes such as an apparatus side processing of an application soft selection process (see FIG. 6), which will be described later, and the processing functions of the application softs 302 to 308.

The information management apparatus 4 is an apparatus for issuing image generation order information upon reception of a request from a doctor, and for adding identification information (hereafter, it is called an order ID) to the issued image generation order information for distinguishing the image generation order information from other image generation order informations, to manage image generation order informations. As the information management apparatus 4, a server in an information management system such as HIS (Hospital Information System), RIS (Radiology Information System) or the like, and a reception terminal for receiving an issuance of image generation order information are applicable.

The JOB manager 5 is a system management apparatus for managing a whole functional structure of the medical system 100. The JOB manager 5 comprises: a CPU; a RAM; a storing unit comprising one of a magnetic recording medium, an optical recording medium and a semiconductor memory; a monitor such as a CRT, a liquid crystal display, a plasma display or the like; an operating section such as a mouse, a keyboard and the like; a communication section for controlling communications to each apparatus on the network N. The JOB manager 5 is equivalent to a designating section of the present invention. By a software process with the combination of the CPU and programs stored in the storing unit, the JOB manager 5 executes a JOB manager side processing of an application soft selection process (see FIG. 6), which will be described later. Further, the JOB manager 5 defines a whole functional structure of the medical system 100.

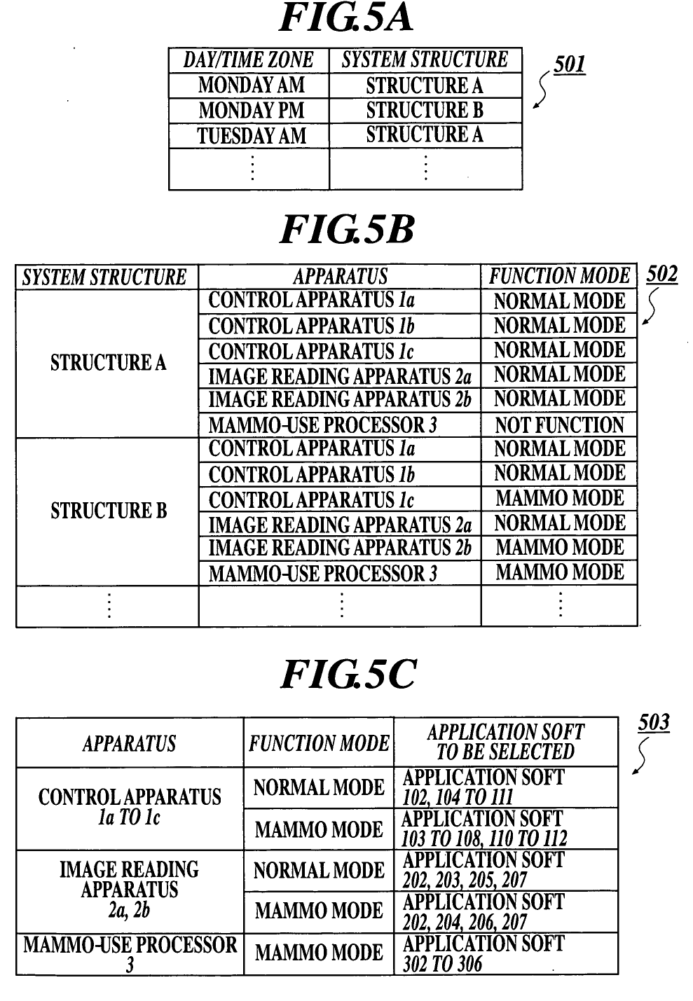

In the present embodiment, the storing unit of the JOB manager 5 comprises a system structure setting table 501; a system structure detail setting table 502; and a selectable application soft list table 503, as shown in FIGS. 5A to 5C.

As shown in FIG. 5A, the system structure setting table 501 stores information indicating a day and a time zone (for example, MONDAY AM, MONDAY PM, TUESDAY AM, . . . ), and information indicating a system structure of the medical system 100 corresponding to the day and the time zone (for example, STRUCTURE A, STRUCTURE B, . . . ) so as to relate each other. The structure of the medical image system corresponding to each day and each time zone is set through the operating section of the JOB manager 5, and therefore it is possible for a user to change, add and delete the setting.

The system structure detail setting table 502 is a table for indicating a detail setting regarding under what function mode each apparatus of the control apparatuses 1a to 1c, the image reading apparatuses 2a and 2b and the mammo-use processor 3c is operated. As shown in FIG. 5B, the system structure detail setting table 502 stores information indicating a system structure of the medical system 100 (for example, STRUCTURE A, STRUCTURE B, . . . ) and information indicating a function mode (for example, NORMAL MODE, MAMMO MODE, . . . ) required to each apparatus of the system structure (for example, CONTROL APPARATUS 1a, CONTROL APPARATUS 1b, CONTROL APPARATUS 1c, . . . ) so as to relate each other. Here, since mammography is required to be a highly-fine image compared to normal images of other parts for image generation, a read pixel size becomes smaller and read data amount thereof becomes larger than the normal images of other parts for image generation. Furthermore, in mammography, data amount of phase contrast mammography (PCM) becomes larger than that of conventional mammography (CM) due to enlargement of a subject (PCM is disclosed in JP-Tokukai-2001-311701A and JP-Tokukai-2001-299733). Assuming same size of a subject, data amount is PCM>CM>normal. In two times enlargement of PCM, data amount ratio is 16:4:1 (PCM>CM>normal). In the medical system 100, the mammo mode is a mode for reading the mammography, applying an image process to the mammography, outputting the mammography, or the like, and the normal mode is a mode for reading a medical image of a part for image generation other than the mammography, applying an image process to the medical image, outputting the medical image, or the like. The setting of a function mode required to each apparatus of each system structure is set through the operating section of the JOB manager 5, and it is possible for a user to change, add and delete the setting.

The selectable application soft list table 503 is a table for indicating an application soft to be selected the application soft corresponding to a processing function to be executed under each function mode by each apparatus. As shown in FIG. 5C, the selectable application soft list table 503 stores information indicating an apparatus (for example, CONTROL APPARATUS 1a to 1c, . . . ), information indicating a function mode (for example, NORMAL MODE, MAMMO MODE, . . . ) and information indicating an application soft (for example, APPLICATION SOFT 102, 104 to 111, . . . ) so as to relate each other.

Here, each of the above-mentioned tables is shown as one example of a table provided for managing a system structure corresponding to each day and each time zone, a function mode of each apparatus of each system structure, and an application soft to be selected under each function mode by each apparatus. The present invention is not limited to such tables.

The image server 6 comprises an image DB (data base). The image server 6 stores data of a medical image which is generated by the image reading apparatuses 2a and 2b and to which various image processes are applied, in the image DB, and the image server 6 distributes the stored medical image data to various apparatuses connected to the network N.

The printer 7 is, for example, an image recording apparatus of a photothermal silver salt type, and outputs a hardcopy on which the image data inputted from the JOB manager 5 is duplicated as a visible image.

Next, an operation of the present embodiment will be described.

FIG. 6 is a flowchart illustrating the application soft selection process performed in the medical system 100. The apparatus side processing of the application soft selection process is, when the control apparatuses 1a to 1c, the image reading apparatuses 2a or 2b, or the mammo-use processor 3 is actuated, executed by the CPU of the actuated apparatus, and the JOB manager side processing of the application soft selection process is executed by the CPU of the JOB manager 5. Hereinafter, descriptions of the application soft selection process will be made by using the case as an example that the control apparatus 1a is actuated and the CPU of the control apparatus 1a executes the apparatus side processing.

When the control apparatus 1a is actuated, the control apparatus 1a is connected to the JOB manager 5 through the network N (Step S1).

When the JOB manager 5 is connected to the control apparatus 1a, the JOB manager 5 refers to the system structure setting table 501, the system structure detail setting table 502 and the selectable application soft list table 503, and searches for an application soft to be selected by the connected apparatus, that is, the control apparatus 1a (Step S2). Then, by transmitting the searched application soft information to the control apparatus 1a through the network N, the application soft to be selected is designated to the control apparatus 1a (Step S3).

When an application soft is designated from the JOB manager 5, in the control apparatus 1a, the designated application soft is selected as an application to be used (Step S4), and the present process is completed.

As above, the description is made by showing the case that the control apparatus 1a performs the apparatus side processing as an example. In addition, approximately the same process is also performed when each of the control apparatuses 1b and 1c, the image reading apparatuses 2a and 2b and the mammo-use processor 3 is turned on. When information indicating that a certain apparatus does not function under a certain function mode is stored (for example, the mammo-use processor 3 in STRUCTURE A) in the system structure detail setting table 502, information indicating that there is no corresponding designated application soft is informed in Step S3.

Here, described is the case that the above-mentioned application soft selection process is performed when each of the control apparatuses 1a to 1c, the image reading apparatuses 2a and 2b and the mammo-use processor 3 is turned on. Here, preferably, the above-mentioned application soft selection process is performed when a predetermined time instant comes, for example, when AM and PM is switched or the like.

Further, it is possible to have a structure where the mammo-use processor 3 does not perform the above-mentioned application soft selection process, but the mammo-use processor 3 functions based on an instruction from the control apparatuses 1a to 1c. For example, the control apparatuses 1a to 1c judge whether a function mode thereof is the normal mode or the mammo mode based on a type of an application program designated by the JOB manager 5, and when a function mode is the mammo mode, the control apparatuses 1a to 1c give an instruction to the mammo-use processor to function, and when one of the control apparatuses 1a to 1c gives the instruction to the mammo-use processor 3 to function, the mammo-use processor 3 makes all the stored applications executable.

In each of the control apparatuses 1a to 1c, the image reading apparatuses 2a and 2b and the mammo-use processor 3, when an application is selected, a processing function is performed based on the selected application soft.

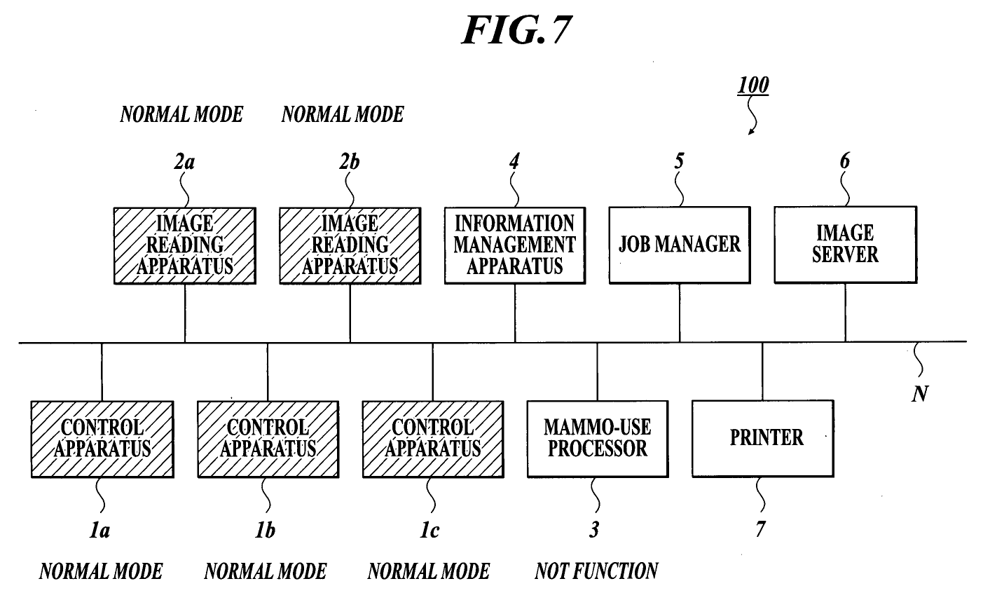

For example, at AM of Monday, the application softs 102, and 104 to 111 are designated to all the control apparatuses 1a to 1c, and as shown in FIG. 7, all the control apparatuses 1a to 1c function under the normal mode. In other words, the control apparatuses 1a to 1c are in a state where it is possible to execute; a function for obtaining image generation order information of other than mammography from the information management apparatus 4; a function for registering a cassette ID of a cassette to be used; a function for relating the image generation order information and the read medical image data; a function for displaying an image; a function for applying a common process (for example, a predetermined gradation process, a rotation process, a mirroring process and the like, of which it is impossible for a user to set a parameter) to the medical image data; a function for setting a parameter of a noncommon process (for example, an equalization process, a gradation process, a frequency process and the like, of which it is possible for a user to set a parameter) to the medical image data; a function for performing a data processing based on the parameter; a function for transmitting processed image data to the printer 7; and a function for transmitting the processed image data to the image DB.

Also, similarly, at AM of Monday, the application softs 203, 203, 205 and 207 are designated to all the image reading apparatuses 2a and 2b, and all the image reading apparatuses 2a and 2b function under the normal mode as shown in FIG. 7. In other words, the image reading apparatuses 2a and 2b are in a state where it is possible to execute: a function for reading a cassette ID of an inserted cassette; a function for reading an image from the cassette (87.5 μm); a function for transmitting the cassette *ID and the read medical image data (small capacity data) to a control apparatus in which the cassette ID was registered; a function for erasing a remaining image from the read cassette; and a function for ejecting the read cassette.

Further, at AM of Monday, since information indicating that there is no corresponding designated application soft is informed to the mammo-use processor 3, as shown in FIG. 7, the mammo-use processor 3 does not function and any function of the application softs 302 to 306 is unexecutable.

In other words, at AM of Monday, as shown in FIG. 7, the whole medical system 100 is so structured to perform normal CR image generation other than mammography.

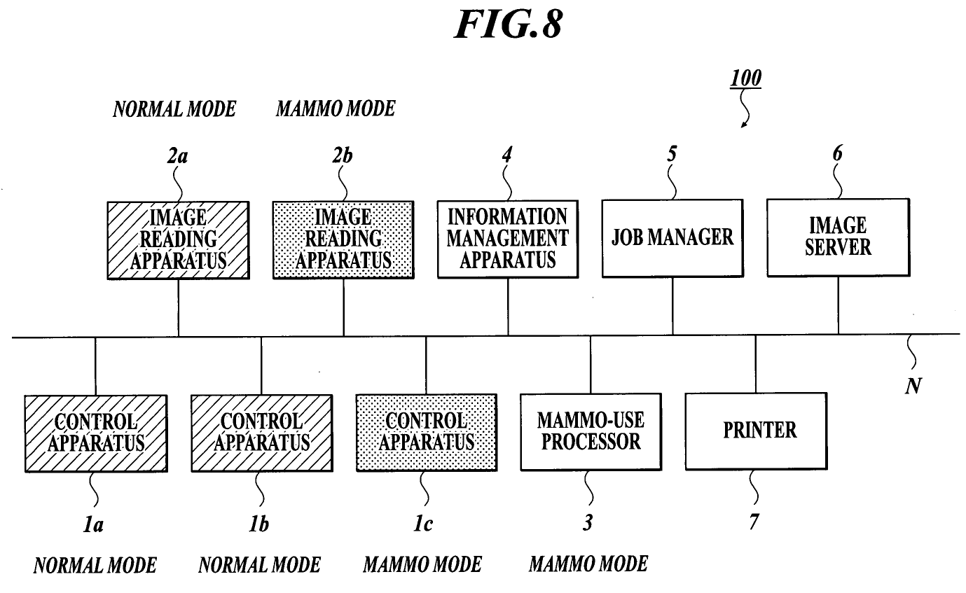

Further, for example, at PM of Monday, the application softs 102 and 104 to 111 are designated to the control apparatuses 1a and 1b, and as shown in FIG. 8, the control apparatuses 1a and 1b function under the normal mode. In other words, the control apparatuses 1a and 1b are in a state where it is possible to execute: a function for obtaining image generation order information of other than mammography from the information management apparatus 4; a function for registering a cassette ID of a cassette to be used; a function for relating the image generation order information and the read medical image data; a function for displaying an image; a function for applying a common process to the medical image data; a function for setting a parameter of a noncommon process to the medical image data; a function for performing a data processing based on the parameter; a function for transmitting processed image data to the printer 7; and a function for transmitting the processed image data to the image DB.

Further, similarly, at PM of Monday, the application softs 103 to 108 and 110 to 112 are designated to the control apparatus 1c, and as shown in FIG. 8, the control apparatus 1c functions under the mammo mode. In other words, the control apparatus 1c is in a state where it is possible to execute: a function for obtaining image generation order information of mammography from the information management apparatus 4; a function for registering a cassette ID of a cassette to be used; a function for relating the image generation order information and the read medical image data; a function for displaying an image; a function for applying a common process to the medical image data; a function for setting a parameter of a noncommon process to the medical image data; a function for transmitting the medical image data and the parameter to the mammo-use processor; a function for transmitting processed image data to the printer 7; and a function for transmitting the processed image data to the image DB.

Further, similarly, at PM of Monday, the application softs 202, 203, 205 and 207 are designated to the image reading apparatus 2a, and as shown in FIG. 8, the image reading apparatus 2a functions under the normal mode. In other words, the image reading apparatus 2a is in a state where it is possible to execute: a function for reading a cassette ID from an inserted cassette; a function for reading an image from the cassette (87.5 μm); a function for transmitting the cassette ID and read medical image data (small capacity data) to a control apparatus in which the cassette ID was registered; a function for erasing a remaining image from the read cassette; and a function for ejecting the read cassette.

Further, similarly, at PM of Monday, the application softs 202, 204, 206 and 207 are designated to the image reading apparatus 2b, and as shown in FIG. 8, the image reading apparatus 2b functions under the mammo mode. In other words, the image reading apparatus 2b is in a state where it is possible to execute: a function for reading a cassette ID of an inserted cassette; a function for reading an image from the cassette (43.75 μm); a function for transmitting the cassette ID and read medical image data (large capacity data) to a control apparatus in which the cassette ID was registered; a function for erasing a remaining image from a read cassette; and a function for ejecting the read cassette.

Further, similarly, at PM of Monday, the application softs 302 to 306 are designated to the mammo-use processor 3, and as shown in FIG. 8, the mammo-use processor 3 functions under the mammo mode. In other words, the mammo-use processor 3 is in a state where it is possible to execute: a function for receiving medical image data from the control apparatus; a function for receiving a parameter from the control apparatus; a function for performing a data processing based on the parameter; a function for transmitting a data processing result to the control apparatus from which the data was received; and a function for displaying an image.

In other words, at PM of Monday, as shown in FIG. 8, the control apparatuses 1a and 1b and the image reading apparatus 2a in the medical system 100 function for normal CR image generation other than mammography, and the control apparatus 1c, the image reading apparatus 2b and the mammo-use processor 3 function for mammography image generation. Thereby, as a whole system, it is possible to carry out both the normal CR image generation and the mammography image generation. Furthermore, since data of heavy amount such as PCM and CM never runs over all of the reading apparatuses and control apparatuses, network busy would hardly occur. Therefore, the whole system is always kept efficiently.

Here, according to a system structure, an IP address of the control apparatus to which medical image data is to be transmitted from the image reading apparatus, an IP address of the mammo-use processor to which medical image data and a parameter are to be transmitted from the control apparatus, and a control apparatus to which processed image data is to be transmitted from the mammo-use processor are restricted. For example, in FIG. 8, medical image data of the image reading apparatus 2a is restricted to be transmitted to the control apparatuses 1a and 1b, and the control apparatuses 1a and 1b are not able to transmit medical image data and a parameter to the mammo-use processor 3. Further, medical image data of the image reading apparatus 2b is restricted to be transmitted to the control apparatus 1c, medical image data and a parameter of the image reading apparatus 2b are restricted to be transmitted to the mammo-use processor 3, and processed image data of the mammo-use processor 3 is restricted to be transmitted to the control apparatus 1c.

In this way, IP addresses to/from which each apparatus can transmit/receive data may be designated to each apparatus, when an application soft is designated to each apparatus from the JOB manager 5 in the above-mentioned application soft selection process, that is, when application soft information is transmitted, so as to transmit the IP addresses to apparatuses having the same function mode. Alternatively, by providing a structure where data communication among each apparatus is done through the JOB manager 5, the JOB manager 5 may distribute IP addresses of the data transmission destinations to each apparatus.

As described above, according to the medical system 100, all the application softs 102 to 112 corresponding to a plurality of types of processing functions required to the control apparatuses 1a to 1c in the medical system 100 are preliminarily stored in the storing unit of each of the control apparatuses 1a to 1c, all the application softs 202 to 207 corresponding to a plurality of types of processing functions required to the image reading apparatuses 2a and 2b in the medical system 100 are preliminarily stored in the storing unit of each of the image reading apparatuses 2a and 2b, all the application softs 302 to 308 corresponding to a plurality of types of processing functions required to the mammo-use processor 3 in the medical system 100 is preliminarily stored in the storing unit of the mammo-use processor 3. Each of the control apparatuses 1a to 1c, the image reading apparatuses 2a and 2b and the mammo-use processor 3 is connected to the JOB manager 5 when each of them is turned on, and based on the system structure setting table 501, the system structure detail setting table 502 and the selectable application soft list table 502, the JOB manager 5 searches for an application soft to be selected by any one of the connected control apparatuses 1a to 1c, the image reading apparatuses 2a and 2b and the mammo-use processor 3, and designates an application soft corresponding to a processing function to be executed to the connected apparatus. In each apparatus, when an application soft is designated from the JOB manager 5, the designated application is selected and the processing function is executed based on the selected application soft.

Therefore, by only designating an application soft corresponding to a processing function to be executed by each apparatus among the application softs preliminarily stored in each apparatus, it is possible to change a functional structure of the medical system 100 quickly. Therefore, although conventionally it was necessary to have a complicated operation that makes a staff of manufacturer individually install an application soft corresponding to a processing function to be executed by each apparatus at each time of changing a functional structure of the system, it is not necessary to do the same any more with the present embodiment. Therefore, it is possible to flexibly change a functional structure of the system.

For example, at a time zone/on a day of when a mammo examination (breast cancer examination) is not performed, application softs of each apparatus are so designated to make the medical system 100 take a functional structure shown in FIG. 7, and at a time zone/on a day of when a mammo examination is performed, application softs of each apparatus are so designated to make the medical system 100 take a functional structure shown in FIG. 8, whereby it is possible to easily make a functional structure of the system changeable according to whether there is a mammo examination.

Further, even when there is changing of a system structure at each day/time zone or when there is adding/deleting of an apparatus to/from the network N, it is only necessary to apply the changing, adding or deleting on the system structure setting table 501, the system structure detail setting table 502 and the selectable application soft list table 503. Therefore, it is possible to flexibly make a functional structure of the system changeable at a user's side, without involving a staff of a manufacturer.

Further, transmission of the processed image data to the printer and transmission of the processed image data to the image DB by the control apparatus can be easily changed to be done by the mammo-use processor, by changing the setting of the selectable application soft list table 503.

Here, the above description of the present embodiment is one suitable example of the medical system 100 relating to the present invention, and the present invention is not limited to the description.

For example, in the present embodiment, described as an example is the case of a system structure being capable of changing between a system structure where the medical system 100 is a system that processes medical image data generated by a CR apparatus using a cassette, in which only normal CR image generation is performed by selecting application softs of each apparatus, and a system structure where normal CR image generation and mammo image generation are performed. However, the present invention is not limited to such a case. For example, the present invention can be applied to a medical system that processes medical image data generated by other types of image generation apparatuses, such as a CT apparatus, an FPD, an ultrasonic diagnosis apparatus and the like. Further, two types of mammography such as PCM and CM are available. In this case, a system comprising a common reading apparatus (fine reading mode) and control apparatuses dedicated for PCM and CM respectively is preferable.

Further, it is possible to have a structure where the application softs used by each apparatus are collectively stored in a server on the network, the JOB manager 5 designates application softs to be installed in each apparatus to the server with IP addresses of each apparatus based on a function mode of the medical system 100, and each apparatus obtains the designated application soft from the server when each apparatus is turned on. In this case, although it takes some amount of time to obtain an application soft, it is possible to reduce a size of an occupied area in the storing unit of each apparatus. Therefore, it is effective when there are comparatively few times of changing a mode. Further, selected one of the control apparatuses could work as the JOB manager.

Further, in the above-mentioned embodiment, described as an example is the case that the present invention is applied to a medical system. However, the present invention is not limited to the case of a medical system, and can be applied to any type of system provided that it is an information processing system comprising a plurality of information processing apparatuses each performing an information process according to a program, the plurality of information processing apparatuses being connected to each other through a network.

And so forth, the detailed structure and the detailed operation of components of the medical system 100 in the present embodiment may be suitably changed without departing the gist of the present invention.

The entire disclosure of a Japanese Patent Application No. 2004-109198, filed on Apr. 6, 2004, including specifications, claims, drawings and summaries are incorporated herein by reference in their entirety.

1. An information processing system comprising a plurality of information processing apparatuses for performing an information process according to a program, the plurality of information processing apparatuses being connected to each other through a network,
wherein a plurality of types of application programs corresponding to a plurality of types of processing functions required in the information processing system are preliminarily stored in each of the plurality of information processing apparatuses,
a designating section designates an application program among the plurality of types of application programs to each of the plurality of information processing apparatuses through the network, the application program corresponding to a processing function to be executed by the each of the plurality of information processing apparatuses, and
the each of the plurality of information processing apparatuses executes the designated application program.

2. A medical system comprising:
an information management apparatus for generating and managing image generation order information;
at least one image generating apparatus for generating medical image data from a subject; and
at least one control apparatus for obtaining the image generation order information from the information management apparatus and the medical image data from one of the at least one image generating apparatus, and for relating the obtained image generating order information and the obtained medical image data;
wherein the information management apparatus, the at least one image generating apparatus and the at least one control apparatus are connected to each other through a network,
a plurality of types of application programs corresponding to a plurality of types of processing functions concerning a generation and a transmission of the medical image data, the plurality of types of processing functions being required in the medical system, are preliminarily stored in each of the at least one image generating apparatus,
a plurality of types of application programs corresponding to a plurality of types of processing functions concerning an obtaining of the image generation order information from the information management apparatus, an obtaining of the medical image data from one of the at least one image generating apparatus and a relation between the obtained image generation order information and the obtained medical image data, the plurality of processing functions being required in the medical system, are preliminarily stored in each of the at least one of control apparatus,
the medical system further comprises a system management apparatus connected to the at least one image generating apparatus and the at least one control apparatus through the network,
the system management apparatus designates an application program among the plurality of types of application programs stored in each of the at least one image generating apparatus and/or the plurality of types of application programs stored in each of the at least one control apparatus to each of the at least one image generating apparatus and/or the at least one control apparatus, the application program corresponding to a processing function to be executed by the each of the at least one image generating apparatus and/or each of the at least one control apparatus, and
the each of the at least one image generating apparatus and/or the at least one control apparatus executes the designated application program.

3. The system of claim 2, wherein
at least one apparatus of the medical system is connected through the network to a data processing apparatus for applying a data processing to the medical image data,
a plurality of types of application programs corresponding to a plurality of types of processing functions concerning a reception of the medical image data from the at least one control apparatus, a reception of the parameter from the at least one control apparatus and a data processing to the received medical image data based on the parameter received from the at least one control apparatus, the plurality of types of processing functions being required in the medical system, are preliminarily stored in the data processing apparatus,
the system management apparatus informs the data processing apparatus through the network, of whether an application program corresponding to a processing function to be executed by the data processing apparatus is designated among the plurality of types of application programs stored in the data processing apparatus or there is no application program to be designated, and
the data processing apparatus executes the designated application program when the system management apparatus designates the application program, or the data processing apparatus does not function when the system management apparatus informs the data processing apparatus that there is no application program to be designated.

4. The system of claim 2, wherein
at least one apparatus of the medical system is connected through the network to a data processing apparatus for applying a data processing to the medical image data,
a plurality of types of application programs corresponding to a plurality of types of processing functions concerning a reception of the medical image data from the at least one control apparatus, a reception of the parameter from the at least one control apparatus and a data processing to the received medical image data based on the parameter received from the at least one control apparatus, the plurality of types of processing functions being required in the medical system, are preliminarily stored in the data processing apparatus,
each of the at least one control apparatus judges whether a function mode thereof is a mammo mode or not based on the type of the application program designated by the system management apparatus, and when the function mode is judged as the mammo mode, each of the at least one control apparatus gives an instruction to the data processing apparatus through the network to function, and
the data processing apparatus performs the plurality of types of application programs stored therein when one of the at least one control apparatus gives the instruction to function.

5. The system of claim 2, wherein selected one of the at least one control apparatus works as the system management apparatus.

6. An information processing method in an information processing system comprising a plurality of information processing apparatuses for performing an information process according to a program, the plurality of information processing apparatuses being connected to each other through a network, the information processing method comprising:
preliminarily storing a plurality of types of application programs in each of the plurality of information processing apparatuses, the plurality of types of application programs corresponding to a plurality of types of processing functions required in the information processing system;
designating an application program among the plurality of types of application programs to each of the plurality of information processing apparatuses, the application program corresponding to a processing function to be executed by the each of the plurality of information processing apparatuses, and
making the each of the plurality of information processing apparatuses execute the designated application program.

7. An information processing method in a medical system comprising: an information management apparatus for generating and managing image generation order information; at least one image generating apparatus for generating medical image data from a subject; and at least one control apparatus for obtaining the image generation order information from the information management apparatus, for obtaining the medical image data from the image generating apparatus, and for relating the obtained image generation order information and the obtained medical image data; wherein the information management apparatus, the at least one image generating apparatus and the at least one control apparatus are connected to each other through a network, the information processing method comprising:
preliminarily storing a plurality of types of application programs corresponding to a plurality of types of processing functions concerning a generation and a transmission of the medical image data in each of the at least one image generating apparatus, the plurality of types of processing functions being required in the medical system, in each of the at least one image generating apparatus;
preliminarily storing a plurality of types of application programs corresponding to a plurality of types of processing functions concerning an obtaining of the image generation order information from the information management apparatus, an obtaining of the medical image data from one of the at least one image generating apparatus and a relation between the obtained image generation order information and the obtained medical image data, the plurality of types of processing functions being required in the medical system, in each of the at least one control apparatus;
making a system management apparatus connected to the at least one control apparatus through the network designate an application program among the plurality of types of application programs stored in each of the at least one image generating apparatus and/or the plurality of types of application programs stored in each of the at least one control apparatus through the network to each of the at least one image generating apparatus and/or each of the at least one control apparatus, the application program corresponding to a processing function to be executed by the each of the at least one image generating apparatus and/or the at least one control apparatus, and
making the each of the at least one image generating apparatus and/or each of the at least one control apparatus execute the designated application program.

8. The method of claim 7, wherein
at least one apparatus of the medical system is through the network connected to a data processing apparatus for applying a data processing to the medical image data,
the method further comprises:
preliminarily storing a plurality of types of application programs corresponding to a plurality of types of processing functions concerning a reception of the medical data from the at least one control apparatus, a reception of a parameter from the at least one control apparatus and the data processing to the received medical image data based on the parameter received from the at least one control apparatus, the plurality of types of processing functions being required in the medical system, in the data processing apparatus;
making the system management apparatus inform the data processing apparatus through the network, of whether an application program corresponding to a processing function to be executed by the data processing apparatus is designated among the plurality of types of application programs stored in the data processing apparatus or there is no application program to be designated; and
making the data processing apparatus execute the designated application program when the system management apparatus designates the application program, and making the data processing apparatus not function when the data processing apparatus is informed that there is no application program to be designated.

9. The method of claim 7, wherein
at least one apparatus of the medical system is connected through the network to a data processing apparatus for applying a data processing to the medical image data,
the method further comprises:
preliminarily storing a plurality of types of application programs corresponding to a plurality of types of processing functions concerning a reception of the medical image data from the at least one control apparatus, a reception of a parameter from the at least one control apparatus and the data processing to the received medical image data based on the parameter received from the at least one control apparatus, the plurality of types of processing functions being required in the medical system, in the data processing apparatus;
making the at least one control apparatus judge whether a function mode thereof is a mammo mode or not based on a type of the application program designated by the system management apparatus, and instruct the data processing apparatus through the network to function when the function mode is judged as the mammo mode; and
making the data processing apparatus execute the plurality of types of application programs stored therein when the at least one control apparatus instructs the data processing apparatus to function.

10. The method of claim 7, wherein selected one of the at least one control apparatus works as the system management apparatus.
